(19) United States
(12) Patent Application Publication
(10) Pub. No.: US 2004/0094140 A1
(43) Pub. Date: May 20, 2004

(54) Barbecue having foot-operated cover-lifting device

(75) Inventor: John Duncan McNair, Olinda (AU)

Correspondence Address: LEYDIG VOIT & MAYER, LTD, 700 THIRTEENTH ST. NW, SUITE 300, WASHINGTON, DC, 20005-3960, US

(73) Assignee: Chiaphua Industries Limited, Tai Po (HK)

(21) Appl. No.: 10/294,908

(22) Filed: Nov. 15, 2002

(51) Int. Cl. A47J 37/00; F24C 3/00

(52) U.S. Cl. 126/25 R; 126/41 R

(57) ABSTRACT

A barbecue has a body with a combustion area and a cooking surface. A cover is attached hingedly to the body, and a foot pedal is situated beneath the combustion area and is attached mechanically to the cover to enable the cover to be lifted or lowered pivotally upon manipulation of the foot pedal. The barbecue further includes legs extending downwardly from the body and the foot pedal is attached to a pedal lever that is attached pivotally to one of the legs.

### BACKGROUND OF THE INVENTION

The present invention relates to barbecues. More particularly, although not exclusively, the invention relates to a gas-fired, or charcoal bed barbecue having a foot-operated cover-lifting/lowering device.

When entertaining guests at a barbecue, the barbecue chef often has his or her hands full. For example, the chef might have barbecue tongs in one hand and a tray of meat in the other. This leaves no hand free for raising and lowering the cover of a covered barbecue and therefore, something must be put down, or an assistant commandeered to raise or lower the cover.

In any case, even if-both hands are not occupied, the barbecue chef might have better things to do with his or her hands while tending a barbecue, than using them to raise and lower the cover.

### OBJECT OF THE INVENTION

It is an object of the present invention to overcome or substantially ameliorate the above disadvantage and/or more generally to provide a barbecue with a foot-operated cover raising/lowering device.

### DISCLOSURE OF THE INVENTION

There is disclosed herein a barbecue comprising:

a body having a combustion area and a cooking surface,

a cover hingedly attached to the body, and

a foot pedal situated lower than the combustion area and attached mechanically to the cover to enable the cover to be lifted or lowered pivotally upon manipulation of the foot pedal.

Preferably the barbecue further comprises legs extending downwardly from the body and the foot pedal is attached to a pedal lever that is attached pivotally to one of the legs.

Preferably the cover includes a lever arm and a cable extends from the lever arm to the pedal lever.

Preferably a spring is positioned between the cover and the body.

Preferably the spring assists in bringing the cover to rest in an open position.

Preferably the spring retains the cover in an open position irrespective of the position of the foot pedal.

Preferably a return spring extends from one of the legs to the pedal lever.

### BRIEF DESCRIPTION OF THE DRAWINGS

Preferred forms of the present invention will now be described by way of example with reference to the accompanying drawings, wherein:

FIG. 1 is a schematic side elevational view of a barbecue having its cover in a closed position,

FIG. 2 is a schematic side elevational view of the barbecue of FIG. 1 with the cover in an open position,

FIG. 3 is a schematic partial side elevational view of the hinged connection of the cover to the barbecue body showing a spring,

FIG. 4 is a schematic partial side elevational view of the barbecue showing a return spring extending between one of its legs and a pedal lever,

FIG. 5 is a schematic side elevational view of a barbecue having an alternative foot pedal mechanism, the view showing the barbecue cover closed,

FIG. 6 is a schematic front elevational view of the barbecue of FIG. 5,

FIG. 7 is a schematic side elevational view of the barbecue of FIG. 5, the view showing the barbecue cover open,

FIG. 8 is a schematic front elevational view of the barbecue of FIG. 7,

FIG. 9 is a schematic side elevational view of a barbecue having yet a further alternative foot pedal mechanism, the view showing the barbecue cover closed,

FIG. 9a is a schematic detailed elevational view of the hinged attachment of the cover to the barbecue of FIG. 9,

FIG. 10 is a schematic front elevational view of the barbecue of FIG. 9,

FIG. 11 is a schematic side elevational view of the barbecue of FIG. 9, the view showing the barbecue cover open,

FIG. 11a is a schematic detailed elevational view of the hinged attachment of the cover to the barbecue of FIG. 11, and

FIG. 12 is a schematic front elevational view of the barbecue of FIG. 11.

### DESCRIPTION OF THE PREFERRED EMBODIMENT

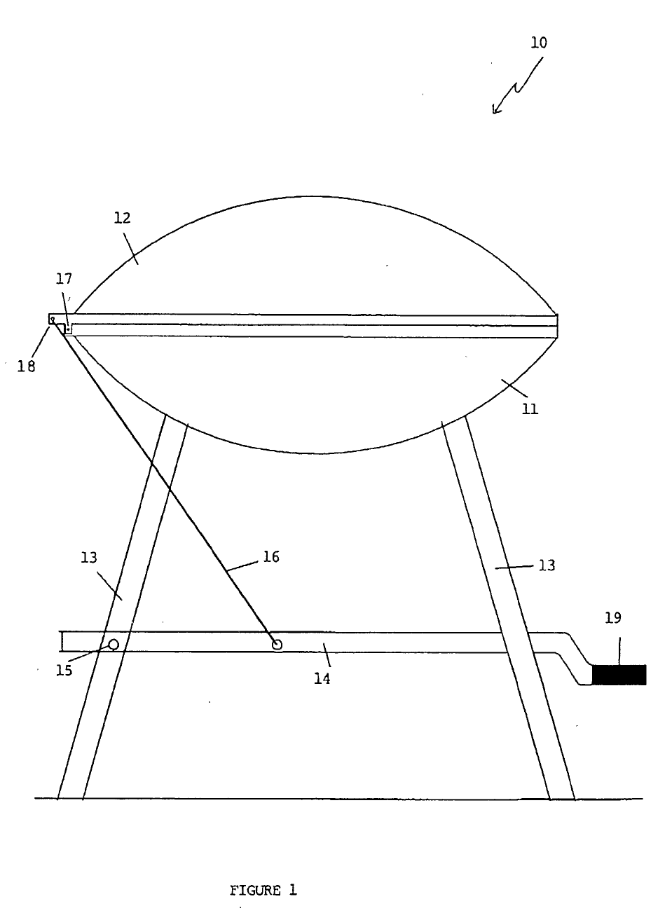

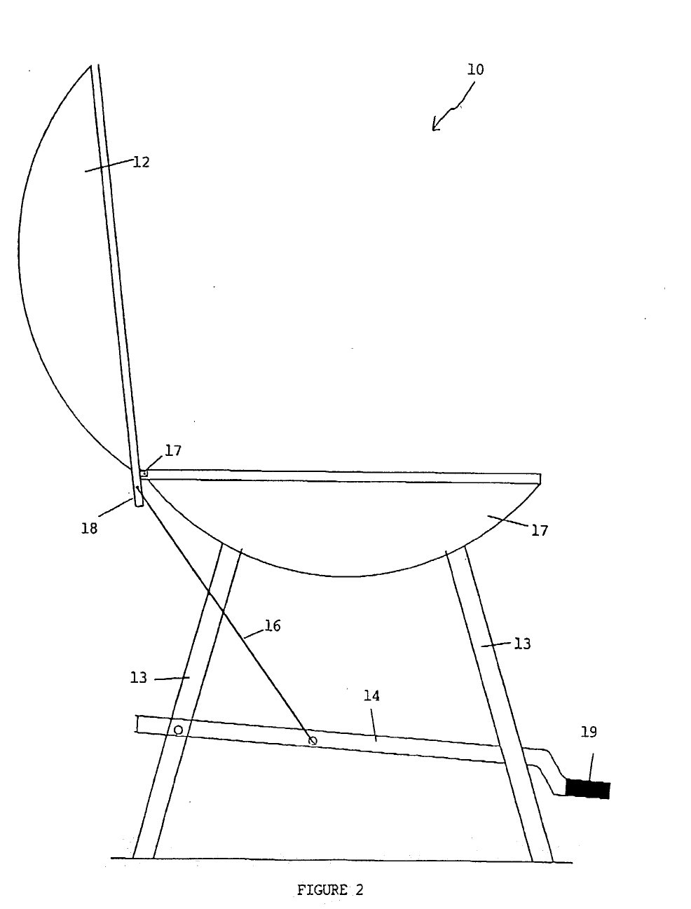

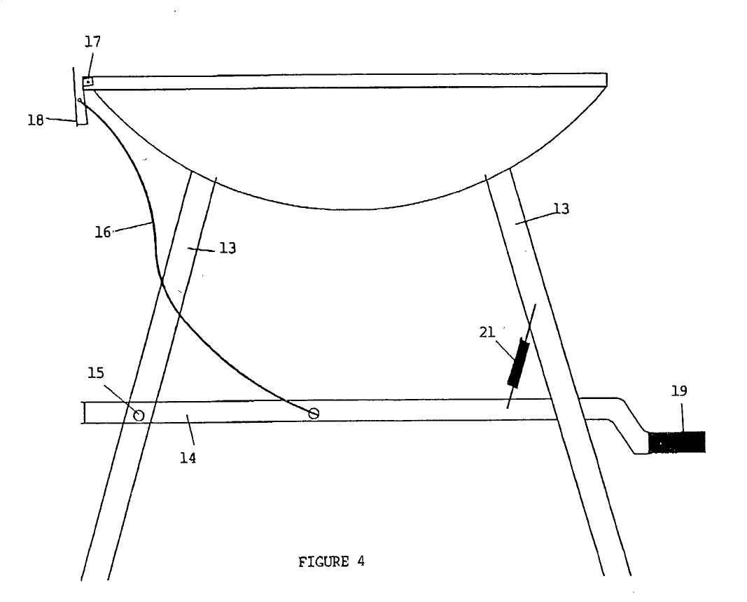

In FIGS. 1 to 4 of the accompanying drawings there is depicted schematically a barbecue 10. Barbecue 10 is typically fabricated from pressed steel that might be galvanised and/or painted or powder coated. The barbecue 10 includes a body 11 having attached hingedly thereto at 17 a cover 12.

Within the body 11 there might be one or more gas burners or a charcoal bed for example. A cooking plate and/or grate (not shown) is located above the combustion area of the body.

Extending downwardly from the body 11 are legs 13. There might typically be three legs when the barbecue is substantially circular when viewed from above. There might be two legs at the back of the barbecue and one at the front. Alternatively, there might be four legs. As yet a further alternative, the barbecue might be mounted upon a wheeled frame, or fixed in a brickwork structure for example.

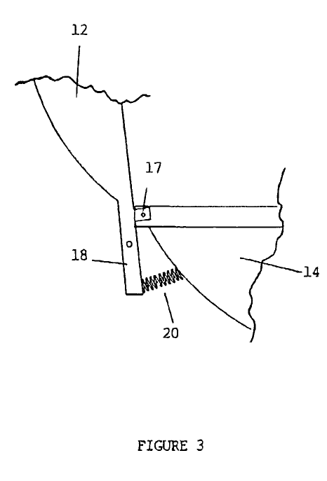

Attached pivotally to the back leg or legs 15 is a pedal lever 14 having a foot pedal 19 at its distal (forward) extremity. A pulling cable 16 extends from a mid-portion of the pedal lever 14 to a lever arm 18 that extends from the cover 12. Depression of the foot pedal 19 pulls the cable 16 downwardly so as to raise the cover 12 pivotally. To provide a buffer against over-travelling of the cover 12, there might be provided a compression spring stop 20 positioned between the lever arm 18 and the body 14 as shown in FIG. 3. In operation, the barbecue chef might stomp on the pedal and the cover might open rapidly. The compression spring stop would assist in settlement of the cover in the open position. The barbecue chef could moderate opening of the cover by keeping his or her foot on the pedal. The cover might stay open by virtue of being over centre. That is, the centre of gravity of the cover might be behind the pivot point. It can be seen that if the user over-travels the pedal, the compression spring stop 20 would be more compressed. Rapid release of the pedal would allow the compression spring stop 20 to bounce the cover back over centre and thus the centre of gravity would be in front of the pivot point enabling it to return to the closed position again. This movement can be moderated by the use of the foot pedal. Decompression spring can act as a means of returning the cover to be closed position when a quick compression occurs by way of stomping on the foot pedal.

In order to return the foot pedal 19 to its rest position, a return spring 21 can extend from one of the front legs 13 to the pedal lever 14.

As an alternative, a rigid operating rod or a Bowden cable could be used instead of a pulling cable. In the case where item 16 is a rigid rod or link, spring 20 might be a tension spring to assist raising of the cover 12. That is, spring 20 would be a tension spring fixed permanently between the lever arm 18 and the body 14 as shown in FIG. 3. When such a tension spring is used, it will assist raising of the cover when opening and then the cover tends to stay open by virtue of the spring and the over-centre location of the cover when raised. In this case, the link 16 must be rigid so that raising the foot pedal can lower the cover.

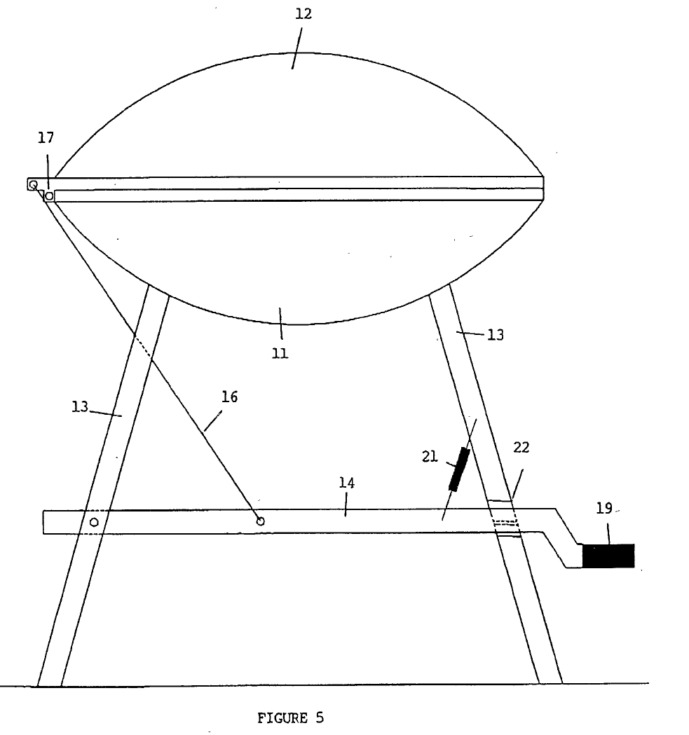

An alternative pedal lever arrangement is shown in FIGS. 5 to 8. In this embodiment, the front leg 13 has extending from it a bracket 22. This bracket might be welded, bolted, riveted or otherwise attached to the leg 13. The pedal lever 14 can be operated so as not to only move vertically, but also laterally so as to be caught under a downwardly extending catch 23 of the bracket 22.

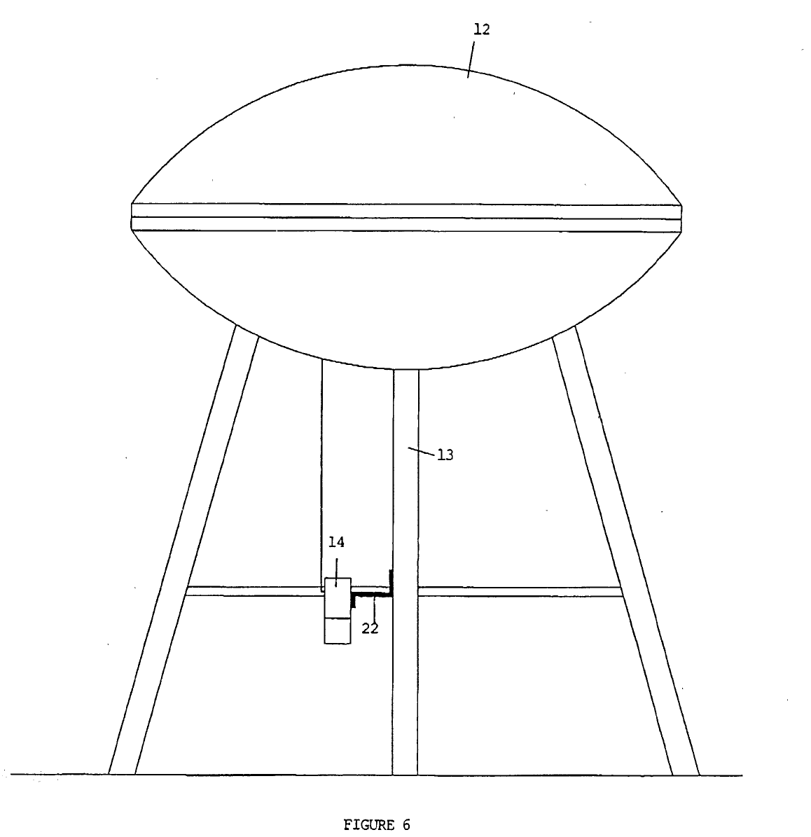

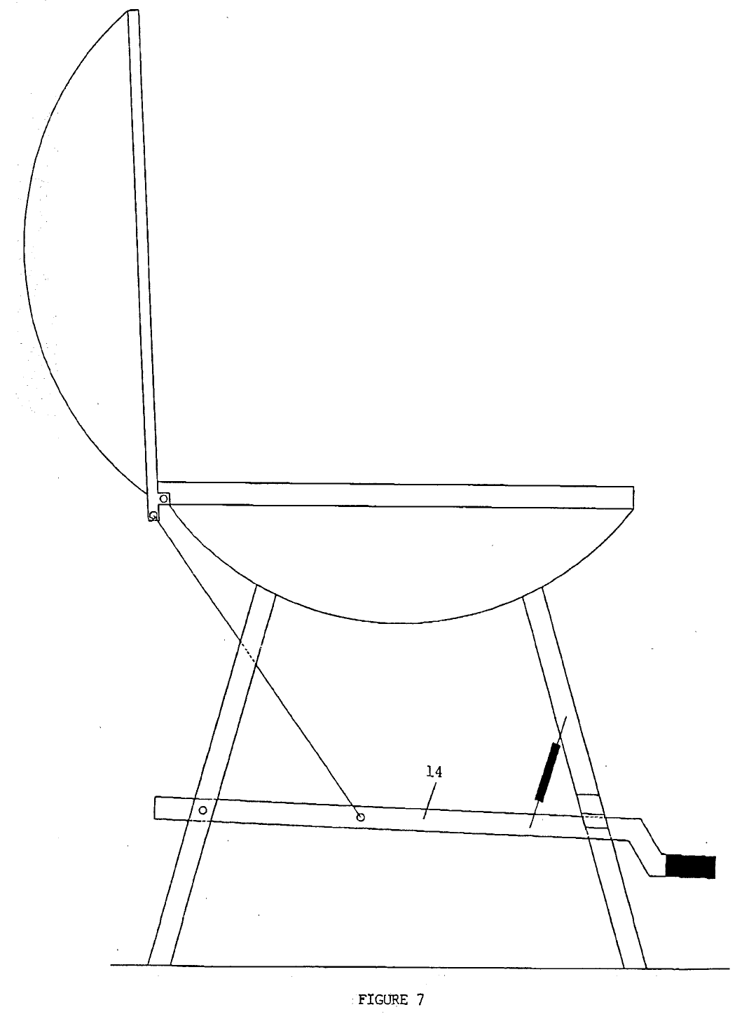

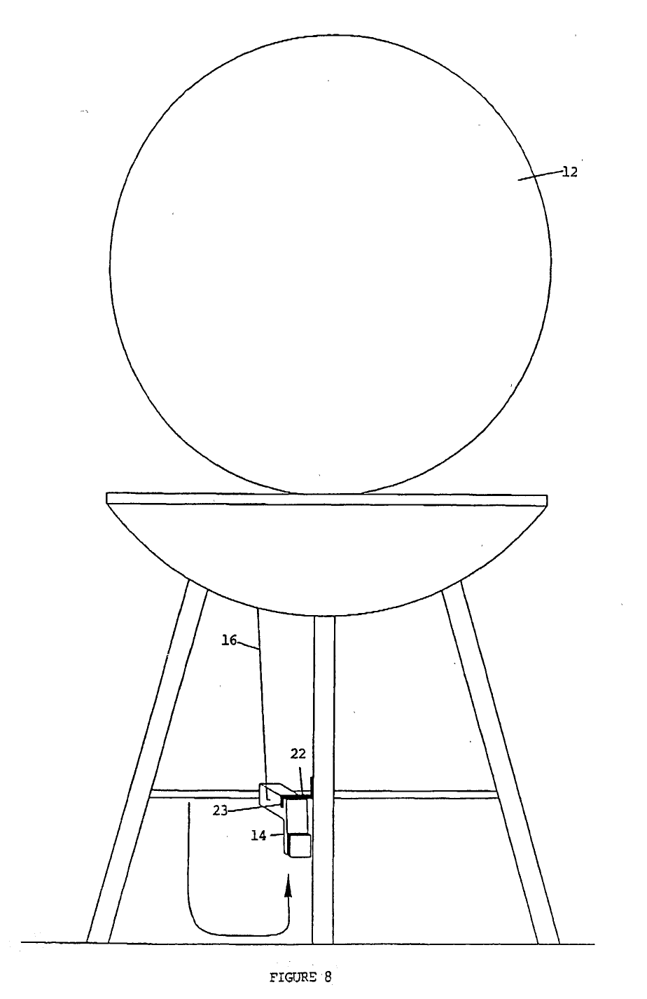

In FIGS. 5 and 6, the pedal lever 14 is shown in position alongside the bracket 22 for vertical movement to act on cable 16 as described earlier. However, when lowered to the level depicted in FIGS. 7 and 8 to thereby raise the corer 12, the pedal lever 14 can be shifted laterally to position underneath the bracket 22 and retained thereagainst by the catch 23. The cover 12 will have pivoted beyond its balance point to therefore maintain tension in the cable 16. This tension will cause an upward force on the pedal lever 14. When it is desired to lower the cover 12, the foot pedal 19 can be depressed and shifted latterly to thereby release the pedal lever 14 from the catch 23.

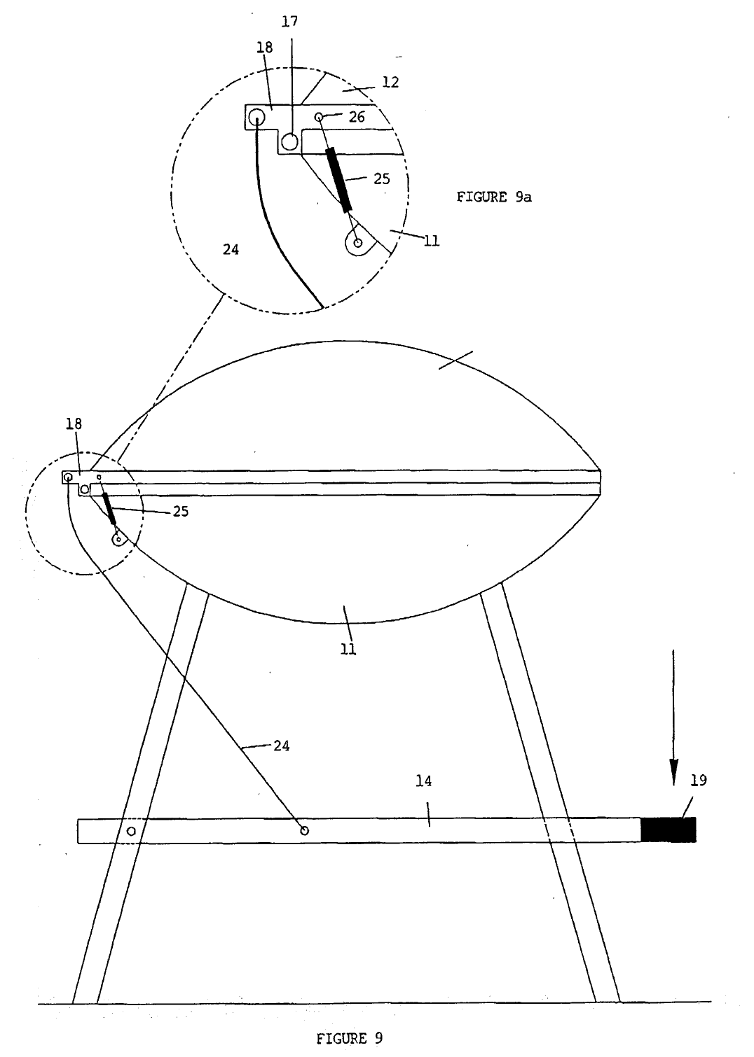

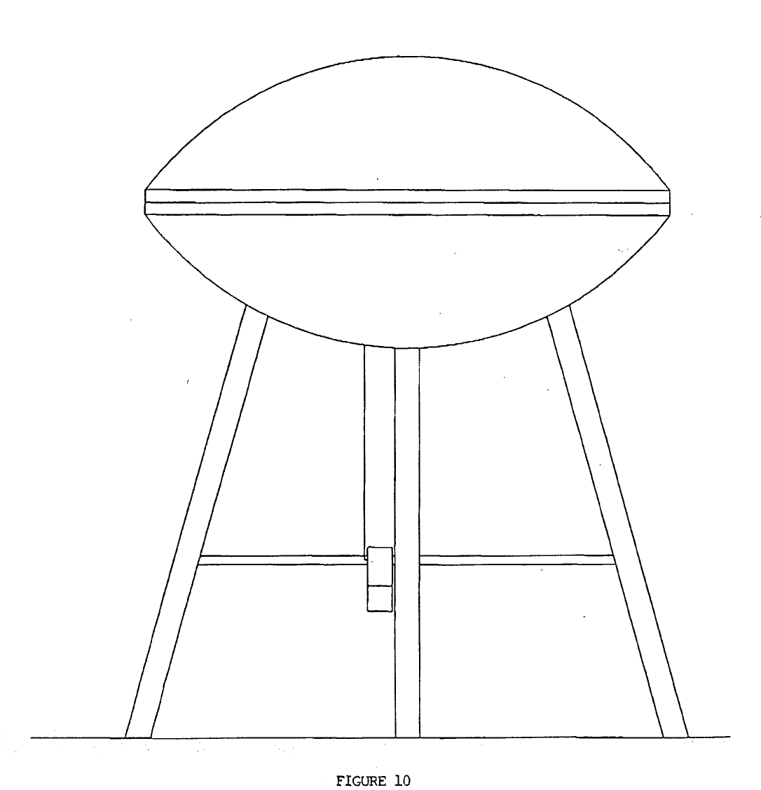

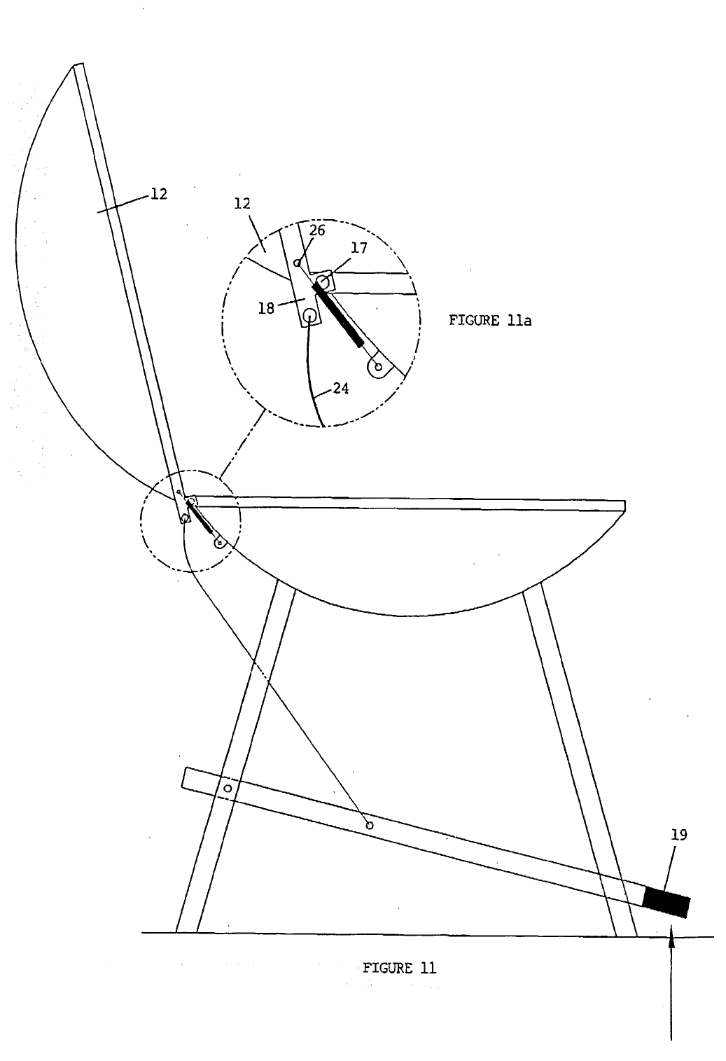

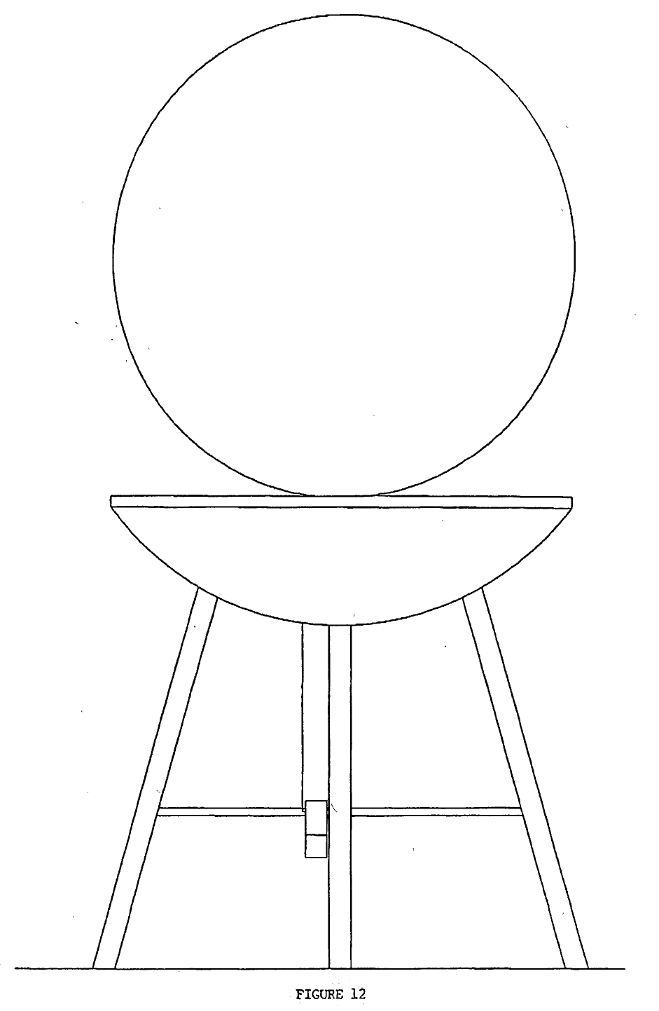

A further embodiment is depicted in FIGS. 9 to 12. Instead of having a cable, there is a rod 24, typically made of metal, extending between the pedal lever 14 and the lever arm 18. In this embodiment, there is no need for a bracket on the front leg is described with reference to FIGS. 5 to 8. Instead, there is a tension spring 25 extending between the mode 11 and the cover 12. The point at which the spring 25 is attached to the cover 12 is alongside the hinge 17 in an over-centre manner. That is, in the closed position of the cover 12 as shown in FIG. 9, the attachment point 26 of spring 25 is forward of the hinge point 17. Tension in the spring 25 maintains a closing force on the cover 12. When the cover 12 is opened by the application of downward force on the foot pedal 19, attachment point 26 moves over the hinge point 17 to the position depicted in FIG. 11 to thereby place and maintain-open force on the cover. The application of an upward force to the foot pedal 19 will close the cover 12.

In all embodiments, the barbecue chef can raise the cover 12 by depression of the foot pedal 19 with his or her foot without having to touch the cover 12.

It should be appreciated that modifications and alterations obvious to those skilled in the art are not to be considered as beyond the scope of the present invention. For example, instead of a cable 16, there might he a system of linkages between the foot pedal 19 and the cover 12.

1. A barbecue comprising:
a body having a combustion area and a cooking surface,
a cover attached hingedly to the body, and
a foot pedal situated lower than the combustion area and attached mechanically to the cover to enable the cover to be lifted or lowered pivotally upon manipulation of the foot pedal.

2. The barbecue of claim 1 further comprising legs extending downwardly from the body and the foot pedal is attached to a pedal lever that is attached pivotally to one of the legs.

3. The barbecue of claim 2, wherein the cover includes a lever arm and a cable extends from the lever arm to the pedal lever.

4. The barbecue of claim 1, wherein a spring is positioned between the cover and the body.

5. The barbecue of claim 4 wherein the spring assists in bringing the cover to rest in an open position.

6. The barbecue of claim 5, wherein the spring retains the cover in an open position irrespective of the position of the foot pedal.

7. The barbecue of claim 5, wherein the spring is attached to the cover in an over-centre configuration to apply a closing force to the cover when the cover is in a closed configuration, and a maintain-open force to the cover when the cover is in an open configuration.

8. The barbecue of claim 2, wherein a return spring extends from one of the legs to the pedal lever.

9. The barbecue of claim 2, wherein there is a bracket attached to one of the legs and with which the pedal lever engages.
